(19) United States
(12) Patent Application Publication
(10) Pub. No.: US 2003/0133739 A1
(43) Pub. Date: Jul. 17, 2003

(54) Rectractable squeezable washing device

(76) Inventors: Sam Zhadanov, Brooklyn, NY (US); Eli Zhadanov, Brooklyn, NY (US)

Correspondence Address: Ilya Zborovsky, 6 Schoolhouse Way, Dix Hills, NY, 11746, US

(21) Appl. No.: 10/050,192

(22) Filed: Jan. 16, 2002

(51) Int. Cl. B43K 5/00; A47L 13/14

(52) U.S. Cl. 401/206; 15/116.2; 15/119.2; 15/205

(57) ABSTRACT

A washing device has a housing; a sponge-like working element associated with the housing; means for squeezing the sponge-like working element after a washing step, the means including a hollow provided in the housing, and a displacing element which displaces the sponge-like working element between a working position in which the sponge-like working element is located outside the hollow of the housing for washing a surface and the like, and a squeezing and/or storage position in which the sponge-like working element is forcedly pulled into the hollow so as to be squeezed and therefore to expel liquid from the sponge-like working element.

### BACKGROUND OF THE INVENTION

The present invention relates to a washing device.

More particularly it relates to a washing device which has a sponge-like working element which can be used for washing of objects and the like by rubbing against such objects with application of water and/or washing solution. The devices of the above mentioned general type are known in the art. It is believed that these devices can be further improved.

### SUMMARY OF THE INVENTION

Accordingly, it is an object of the present invention to provide a washing device which is a further improvement of the existing devices.

In keeping with these objects and with others which will become apparent hereinafter, one feature of present invention resides, briefly stated, in a washing device which has a housing; a sponge-like working element associated with said housing; means for squeezing said sponge-like working element after a washing step, said means including a hollow provided in said housing, and a displacing element which displaces said sponge-like working element between a working position in which said sponge-like working element is located outside said hollow of said housing for washing a surface and the like, and a second non-working position in which said sponge-like working element is forcedly pulled into said hollow so as to be squeezed by pressing against an inner wall of said housing and therefore to expel liquid from said sponge-like working element so as to keep it contained in smaller area, and to keep dirt and bugs away.

In accordance with another feature of present invention the washing device has said means for displacing which includes a displacing element, and an element which connects said displacing element with said sponge-like working element.

The connecting element can be a button-like element with one flange engaged in said displacing element and a second flange engaged with said sponge-like working element, and also with a brush portion for cleaning and/or an opening for supplying a washing substance.

In accordance with another feature of the invention, both, sponge-like working element and connecting element with brush portion, can be replaced after they wear out.

In accordance with another feature of the invention the displacing said spacing element is formed as a handle and also may have an inner chamber, or flange for accommodating a washing solution or a container containing a washing solution etc.

When the washing device is designed in accordance with the present invention, it provides a simple and efficient washing of objects and the like, and subsequent squeezing of the sponge-like working element.

It also makes possible a convenient mounting of the sponge-like working element on the device, a quick and complete squeezing of water for fast and complete squeezing of water from the sponge-like element for cleaning the same, and also a supply of washing substance, as well as storing of the working element in the enclosed chamber.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a view showing a washing device in accordance with the present invention in an operative position with a sponge-like working element located outside of the housing for washing purposes; and

FIG. 2 is a view substantially corresponding to the view of FIG. 1 but showing the sponge-like working element in a position in which it is squeezed for removing water and impurities.

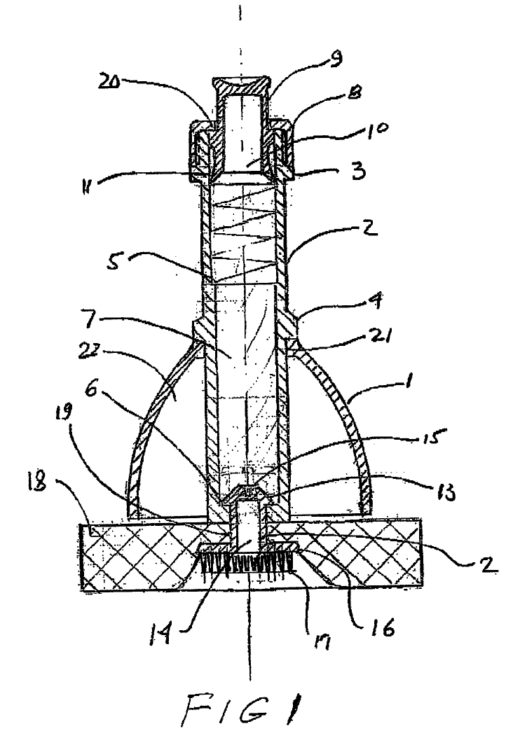

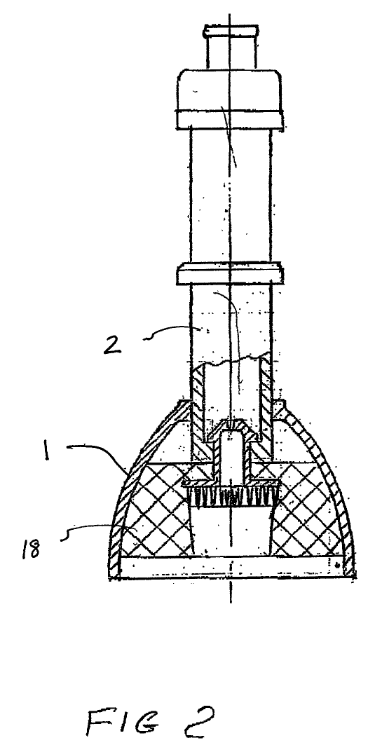

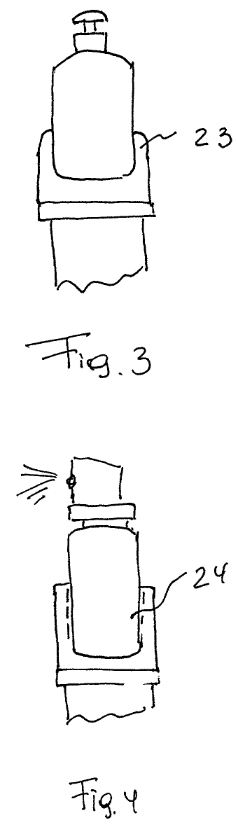

### DESCRIPTION OF THE PREFERRED EMBODIMENTS

A washing device in accordance with the present invention has a housing which is identified with reference numeral 1 and has an inner hollow of an arbitrary shape. The device further has a hollow cylindrical handle 2 having flanges 3 and 4 on its outer surface and projections 5 and 6 on its inner surface inside an opening 7. The flange 3 is provided with a threaded nut 8. A pusher 9 is located inside the threaded nut 8 and has a piston 10 with a sealing flange

In a lower part of the handle, there is connecting element 12 which can be knob-like and can have a conical flange 13 and an openings 14 and 15. The connecting 12 is composed for example of an elastic plastic material and ends in a disk 16 provided with a brush 17.

A sponge-like working element 18 is mounted by the connecting element 12 to the lower part of the handle. It has a cylindrical shape with an opening 19 in its center.

The device operates in the following manner.

The inner chamber 7 of the hollow handle 2 is filled with a washing substance, for example a liquid soap, through an opening 20 and is closed with the piston 10 and the nut 8. The injection of soap is performed by pressing of the pusher 9 and the piston 10. The supply of soap is performed through the openings 15 and 14.

The cylindrical handle 2 is telescopically movable in the opening 21. It can retract the sponge-like working element 18 into a hollow 22 of the housing 1 so as to squeeze out a liquid from the sponge-like working element 18, and thereafter to move the sponge-like working element out of the hollow 22 for washing purposes. A multiple moving in and out of the sponge-like working element 18 provides an efficient cleaning of pores of the sponge-like working element from grease and dirt. The storage of the sponge-like working element 18 inside the hollow 22 of the housing ensures its cleanness and also provides aesthetic appearance of the device.

In accordance with another embodiment shown in FIGS. 3 and 4, means are provided for holding a container for a washing solution, which can be squeezable or a piston type arid can contain liquid soaps, perfume sprays, etc. in FIG. 3 the means is formed as a connecting flange 23 which can hold the container by springy action, while in FIG. 4 the means is formed as a thread 24 provided on the container and is the handle.

It will be understood that each of the elements described above, or two or more together, may also find a useful application in other types of constructions differing from the types described above.

While the invention has been illustrated and described as embodied in washing device, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by LETTERS PATENT is set forth in the appended claims:

1. A washing device, comprising a housing; a sponge-like working element associated with said housing; means for squeezing said sponge-like working element after a washing step, said means including a hollow provided in said housing, and a displacing element which displaces said sponge-like working element between a working position in which said sponge-like working element is located outside said hollow of said housing for washing a surface and the like, and a non-working position in which said sponge-like working element is forcedly moved into said hollow so as to be squeezed and therefore to expel liquid from said sponge-like working element.

2. A washing device as defined in claim 1, wherein said means for displacing includes a displacing element, and a connecting element which connects said displacing element with said sponge-like working element.

3. A washing device as defined in claim 2, wherein said connecting element has one flange engaged with said displacing element and another flange engaged with said sponge-like working element.

4. A washing device as defined in claim 3, wherein said connecting element is provided with a brush-portion.

5. A washing device as defined in claim 1, wherein said connecting element has an opening for supplying a washing substance.

6. A washing device as defined in claim 1, wherein said displacing means include a displacing element formed as a handle.

7. A washing device as defined in claim 6, wherein said displacing element formed as a handle has an inner chamber for accommodating a washing solution.

8. A washing device as defined in claim 7; and further comprising passage means for displacing the washing solution from said inner chamber through the washing device to a surface to be washed.

9. A washing device as defined in claim 1, wherein said housing contains an inner chamber for accommodating a washing solution.

10. A washing device as defined in claim 1; and further comprising means for holding a container for washing solution.

11. A washing device as defined in claim 10, wherein said holding means include a holding flange.

12. A washing device as defined in claim 10, wherein said holding means include a holding thread.

13. A washing device as defined in claim 1, wherein said hollow is formed so as to confine said working element in a compressed condition.

14. A washing device as defined in claim 7, wherein said hollow is formed so as to continue said working element in a compressed condition.
